(19) United States
(12) Patent Application Publication
(10) Pub. No.: US 2010/0162573 A1
(43) Pub. Date: Jul. 1, 2010

(54) Tool for removing caulk bead

(76) Inventor: Eric Liao, Taichung (TW)

Correspondence Address: SAM CHEN, 7F-1, 293, ROOSEVELT ROAD, SEC 3, TAIPEI, TW

(21) Appl. No.: 12/346,905

(22) Filed: Dec. 31, 2008

(51) Int. Cl. B26B 3/00

(52) U.S. Cl. 30/169

(57) ABSTRACT

A tool for removing a bead of caulk from a joint at the intersection of two adjacent surfaces is provided. The tool includes an arcute handle comprising a friction section on an upper surface; and a hollow scraping section at the head of the handle and comprising a left plane, a right plane, a front tip, a bottom tip, a front edge at the intersection of the left plane and the right plane, and a bottom edge. In one operating mode the front tip, the left plane, and the right plane are adapted to cut and lift the bead from the adjacent surfaces of the joint by inserting the front tip into the bead by pushing the tool. Preferably, the left plane is at an angle of about 90 degrees with respect to the right plane.

### BACKGROUND OF THE INVENTION

1. Field of Invention

The invention relates to tools for scraping cured beads of caulk, sealant or other previously fluent materials (“caulk”) from joints, and more articularly to such a tool for removing caulk bead with improved characteristics.

2. Description of Related Art

Many conventional tools are available to facilitate the removal of caulk from joints. For example, U.S. Pat. No. 6,035,536 discloses a caulk bead removal tool comprising an elongate handle with two working heads. The primary working head at one end of the longitudinal axis of the handle features a chisel-like point angled down from the upper face of the handle and extending between two symmetrical flanking planes which are acutely angled to each other and also spread from the body of the handle. The planes are beveled to form sharp edges for scraping surfaces during an operation to remove a bead whilst the chisel-like point chisels the body of the bead from the joint. Axially opposite the primary head the second working head is essentially an angled chisel-like point extended from the upper face of the handle and is used to chisel, pick or gouge a bead from a joint of at the intersection of two adjacent surfaces. Thus, continuing improvements in the exploitation of tool for removing caulk bead are constantly being sought.

### SUMMARY OF THE INVENTION

It is therefore one object of the invention to provide a tool for removing a bead of caulk from a joint at the intersection of two adjacent surfaces.

The above and other objects, features and advantages of the invention will become apparent from the following detailed description taken with the accompanying drawings.

### BRIEF DESCRIPTION OF THE DRAWINGS

FIG. 1 is a perspective view of a preferred embodiment of tool for removing caulk bead according to the invention;

FIG. 2 is a perspective view of the tool operating in a first mode (i.e., pushing) for removing a bead of caulk from a joint at the intersection of a wall and a floor; and

FIG. 3 is a view similar to FIG. 2, where the tool is operating in a second mode (i.e., pulling).

### DETAILED DESCRIPTION OF THE INVENTION

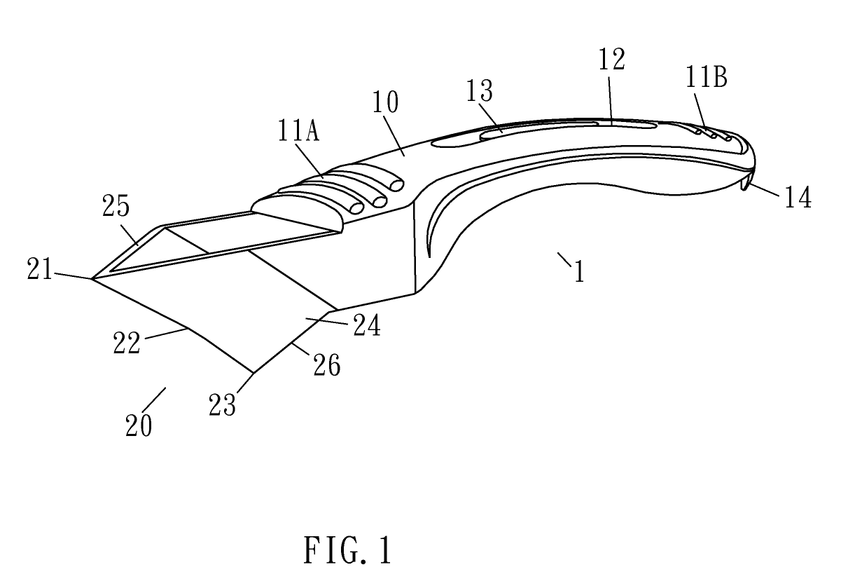

Referring to FIG. 1, a tool 1 for removing caulk bead in accordance with a preferred embodiment of the invention comprises the following components as discussed in detail below.

An elongated, slightly curved handle 10 comprises a downward sharp point 14 in the rear. On upper surface of the handle 10 there are provided, from front to rear, a first ribbed member 11 A, an elongated recess 12, a projection 13 formed in the recess 12, and a second ribbed member 11B.

A scraping section 20 is formed integrally with a front portion of the handle 10. The scraping section 20 is hollow and has a left plane 25, a right plane 26, a front tip 21, a bottom tip 23, a front edge 22 at the intersection of the left plane 25 and the right plane 26, and a bottom edge 24. Preferably, the left plane 25 is at an angle of about 90 degrees with respect to the right plane 26.

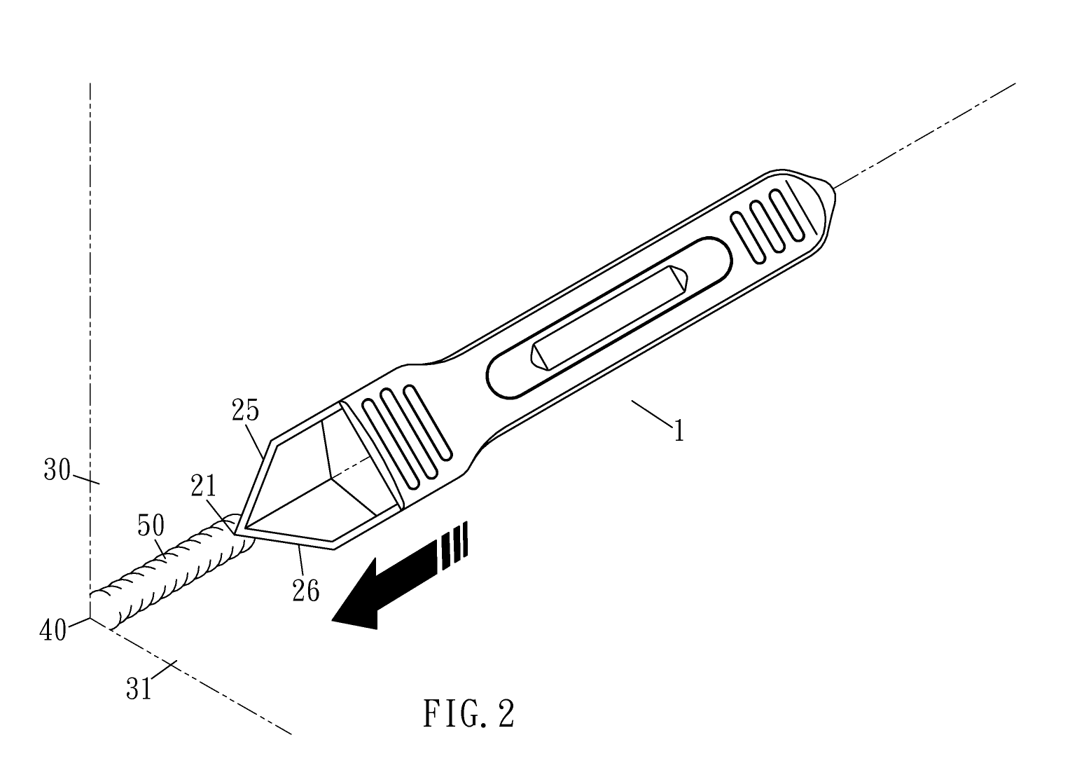

Referring to FIG. 2, a first operating mode of the tool 1 is illustrated. A user may place the tool 1 in the rear end of a bead of caulk 50 in a joint 40 at the intersection of a first surface 30 (e.g., a wall) and a second surface 31 (e.g., floor) perpendicular to the first surface 30. In detail, the front tip 21 is engaged with the caulk 50, the left plane 25 is engaged with the wall 30, the right plane 26 is engaged with the floor 31, and the tool 1 is at an acute angle with respect to the joint 40. Thereafter, the user push the tool 1 forward to scrap the caulk 40 as indicated by arrow.

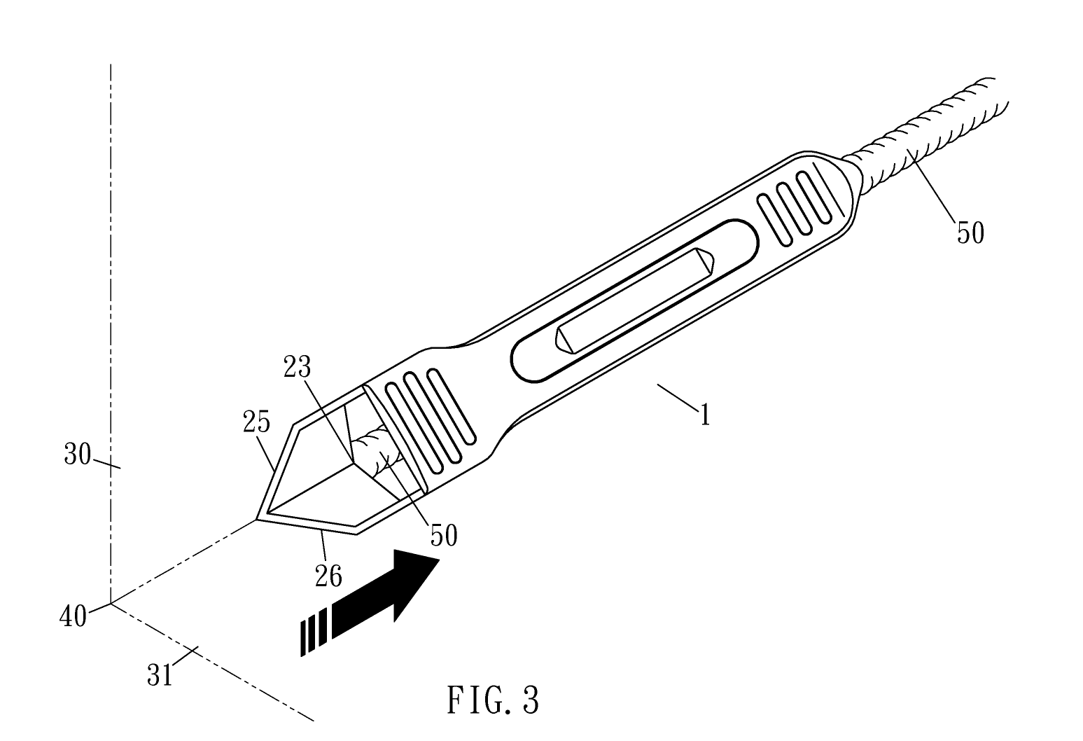

Referring to FIG. 3, a second operating mode of the tool 1 is illustrated. A user may place the tool 1 in the front end of a bead of caulk 50 in a joint 40 at the intersection of a first surface 30 (e.g., a wall) and a second surface 31 (e.g., floor) perpendicular to the first surface 30. In detail, the bottom tip 23 is engaged with the caulk 50, the left plane 25 is engaged with the wall 30, the right plane 26 is engaged with the floor 31, and the tool 1 is at an acute angle with respect to the joint 40. Thereafter, the user pull the tool 1 rearward to scrap the caulk 40 as indicated by arrow.

Note that the rear point 14 can be employed to press into a relatively deep caulk 50 for loosening prior to the caulk removal operation.

While the invention herein disclosed has been described by means of specific embodiments, numerous modifications and variations could be made thereto by those skilled in the art without departing from the scope and spirit of the invention set forth in the claims.

What is claimed is:

1. A tool for removing a bead of caulk, sealant or other material from a joint at the intersection of two adjacent surfaces, comprising:
an elongated arcute handle comprising a friction section on an upper surface; and
a scraping section formed integrally with a front end of the handle, the scraping section being hollow and comprising a left plane, a right plane, a front tip, a bottom tip, a front edge at the intersection of the left plane and the right plane, and a bottom edge,
wherein in a first operating mode the front tip, the left plane, and the right plane are adapted to cut and lift the bead from the adjacent surfaces of the joint by inserting the front tip into the bead by pushing the tool; and
wherein in a second operating mode the bottom tip, the left plane, and the right plane are adapted to cut and lift the bead from the adjacent surfaces of the joint by inserting the bottom tip into the bead by pulling the tool.

2. The tool of claim 1, wherein the left plane is at an angle of about 90 degrees with respect to the right plane.

3. The tool of claim 1, wherein the friction section comprises a first ribbed member adjacent the scraping section, an elongated recess behind the first ribbed member, a projection in the recess, and a second ribbed member behind the recess.
